(19) United States
(12) Patent Application Publication
(10) Pub. No.: US 2026/0009410 A1
(43) Pub. Date: Jan. 8, 2026

(54) HYDRODYNAMIC RETARDER INCLUDING A WORKING MEDIUM TANK

(71) Applicant: Voith Patent GmbH, Heidenheim (DE)

(72) Inventors: Dieter Laukemann, Frankenhardt (DE); Alexander Martin, Kressberg (DE); Martin Blumenstock, Frankenhardt (DE)

(73) Assignee: Voith Patent GmbH, Heidenheim (DE)

(21) Appl. No.: 19/324,818

(22) Filed: Sep. 10, 2025

Related U.S. Application Data
(63) Continuation of application No. PCT/EP2024/055939, filed on Mar. 7, 2024.

(30) Foreign Application Priority Data
Mar. 10, 2023 (DE) 10 2023 105 956.4

(51) Int. Cl. F15B 21/0423; F15B 21/00

(52) U.S. Cl. CPC F15B 21/0423; F15B 21/005

(57) ABSTRACT

A hydrodynamic retarder includes: a retarder chamber in which a rotor and a stator are arranged, the rotor and the stator together forming a working chamber that can be filled with and emptied of a working medium; a working medium tank, including a sump region, a storage region, and an expansion region, the sump region and the storage region for accommodating the working medium that is not currently in the working chamber; at least one filling channel for supplying the working medium into the working chamber; a return channel for discharging the working medium from the working chamber; a rotor housing; a stator housing; a tank housing; a coupling level, which is arranged on the tank housing below the sump region; and an additional channel, which runs through the coupling level and is configured for direct or indirect coupling to an outlet of a primary side of a heat exchanger.

### CROSS REFERENCE TO RELATED APPLICATIONS

This is a continuation of PCT application no. PCT/EP2024/055939, entitled “HYDRODYNAMIC RETARDER COMPRISING A WORKING MEDIUM TANK”, filed Mar. 7, 2024, which is incorporated herein by reference. PCT application no. PCT/EP2024/055939 claims priority to German patent application no. 10 2023 105 956.4, dated Mar. 10, 2023, which is incorporated herein by reference.

### BACKGROUND OF THE INVENTION

### 1. Field of the Invention

The present invention relates to hydrodynamic retarders.

### 2. Description of the Related Art

Hydrodynamic retarders include a working chamber that can be filled with and emptied of working medium. A torque is transferred from a bladed rotor to a bladed stator with the assistance of the working medium. When the working chamber is filled, the rotor and thus a shaft that is designed to rotate with the rotor, for example a drive shaft or transmission output shaft that is indirectly connected to the wheels of a vehicle, is decelerated.

A retarder and its working medium circuit are known from DE 10 2013 006 611A1. The rotor and stator of the retarder form a toroidal working chamber, which is connected via a duct system to a working medium circuit with a working medium tank. Venting of the working chamber occurs via a ventilating system, through which air can escape into the environment through a connection between the working chamber and the environment. The working medium tank can be connected to a compressed air connection or the environment via a valve, the MRCU.

To switch the retarder to braking mode, the working medium tank must be supplied with compressed air via the MRCU, so that the working medium is moved via the filling channel from the working medium tank into the working chamber. The filling channel is arranged in the working medium tank in such a way that its inlet opening terminates in the lower region of the working medium tank, ensuring that the inlet opening of the filling channel is below the working medium level in any operating condition, preventing air from entering the filling channel.

When switching the retarder into non-braking mode, the working medium tank must be deventilated and the working chamber ventilated. The working medium is thereby pumped from the retarder via the heat exchanger back into the working medium tank.

What is needed in the art is a retarder with reduced manufacturing and assembly costs.

### SUMMARY OF THE INVENTION

The invention relates to the structure of a hydrodynamic retarder for a motor vehicle, in particular to the structure of the working medium tank of the retarder.

The present invention provides a retarder including a retarder chamber in which a rotatably mounted rotor and a stator are arranged, which together form a working chamber that can be filled with and emptied of working medium. The retarder also includes a working medium tank which has a region to accommodate working medium that is not currently in the working chamber, and an expansion region, at least one filling channel for feeding working medium into the working chamber and a return channel for discharging working medium from the working chamber, as well as a rotor housing, a stator housing, and a tank housing.

The present invention provides that the working medium tank includes a storage region and a sump region, and that a coupling level is arranged on the tank housing below the sump region, through which at least one second channel runs, which is suitable for direct or indirect coupling to the outlet of the primary side of a heat exchanger.

Moreover, a first channel can be arranged in the tank housing, via which a direct or indirect coupling with the inlet of the primary side of the heat exchanger can be established. In an optional design, the first channel can be arranged above the second channel. This arrangement allows for the sealing level to be decoupled. This means that the sealing level between the tank housing and the intermediate part can be axial in one case and radial in another, which simplifies production.

The filling tube optionally extends into the sump region, wherein the inlet opening into the filling tube is covered by at least 20 mm to 50 mm working medium in every operating state. Thus, the inlet opening of the filling tube is sufficiently submerged in working medium in all operating states, so that no air can be sucked in through the filling tube. It is moreover advantageous if the inlet opening of the filling tube is located centered above the second channel.

Moreover, an intermediate component may be provided between the tank housing and the heat exchanger in one design, wherein channels are integrated into the intermediate component, by way of which the first channel is connected to the inlet and the second channel is connected to the outlet of the primary side of the heat exchanger.

Additional channels may also be integrated into the intermediate component, by way of which the secondary side of the heat exchanger can be connected to a cooling circuit. The intermediate component can be designed as a cast part with cast-in channels.

In an additional embodiment, an outlet can be provided in the intermediate component through which the working medium can be drained from the working medium tank and the primary circuit of the heat exchanger. A second outlet is optionally provided on the intermediate component through which cooling medium can be drained from the secondary circuit of the heat exchanger.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a sectional sketch of a retarder; and

FIG. 2 is an oil tank with sump and intermediate component.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

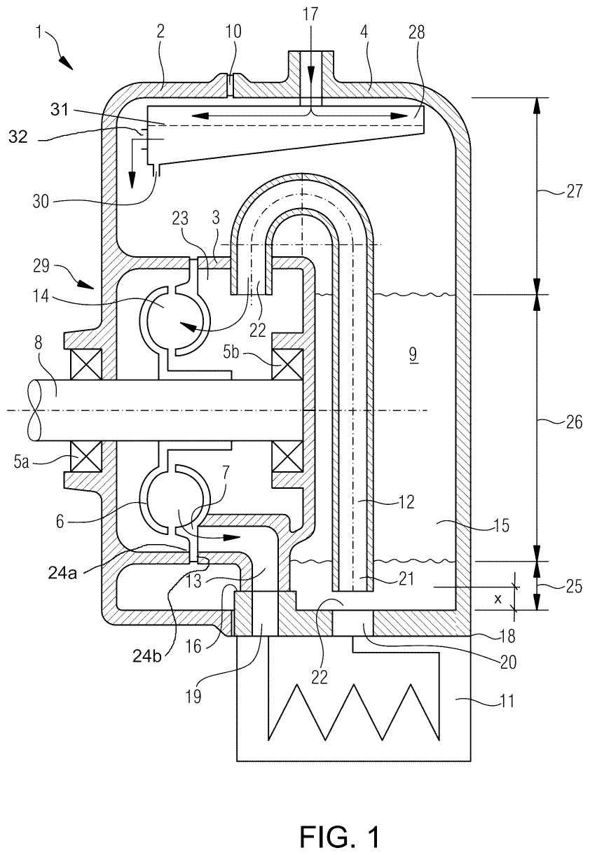

The sketch in FIG. 1 illustrates the basic structure of retarder 1. The outer enclosure of retarder 1 consists essentially of two parts: rotor housing 2 and stator housing 3, each of which forms a half-shell of the housing. Housing parts 2 and 3 enclose a cavity, which is divided into three regions. Cavity region 27, storage region 26, and retarder region 29 are provided.

Together, cavity region 27, storage region 26, and retarder region 29 form working medium tank 15, wherein working medium 9 accumulates in storage region 26 and sump region 25 when the retarder is switched to non-braking mode.

Cavity region 27 is a space, designed essentially to ensure that no working medium can get into the compressed air control—also referred to as MRCU—via connection 17. A working medium separator or oil separator 28 is provided between connection 17 and working medium tank 15. Separated oil can flow back into working medium tank 15 via outlet 30.

During braking operation, the compressed air control regulates the braking torque of retarder 1. The higher the air pressure in cavity region 27 the more working medium 9 is forced from working medium tank 15 into the retarder circuit.

The region between rotor housing 2 and stator housing 3 is referred to as retarder region 29. Rotor 6, stator 7, bearing-mounted rotor shaft 8, and channels for conveying the working medium are located in retarder region 29. As is known from the current state of the art, rotor 6 can be arranged axially movable on rotor shaft 8.

A coupling level 18 is provided on tank housing 4, to which heat exchanger 11 can be attached directly or indirectly, wherein first channel 19 and second channel 20 are provided in coupling level 18. Via first channel 19, working chamber 14 is connected between rotor 6 and stator 7 to the flow connection of heat exchanger 11, and the outlet of heat exchanger 11 is connected to working medium tank 15 via second channel 20. Cooled working medium 9 enters working medium tank 15 via second channel 20 when switching to non-braking mode, in other words, when the pressure in expansion region 27 drops.

Moreover, a filling channel 12 is provided, which establishes a connection from lower sump region 25 into inlet chamber 23, which in turn is connected to working chamber 14 via channels in stator 7, not shown.

When switching the retarder into braking mode, the air pressure in expansion region 27 is increased via connection 17, as a result of which working medium 9 enters working chamber 14 via filling channel 12, inlet chamber 23, and the channels in stator 7. The known pumping action of retarder 1 causes working medium 9 to be pumped back from the working chamber via return channel 13, first channel 19, heat exchanger 11, and second channel 20 into working medium tank 15.

Filling channel 12 is arranged relative to second channel 20 in such a way that working medium 9 flowing out of second channel 20 can flow via inlet opening 21 into filling channel 12. In braking mode, this creates a circular flow, whereby working medium 9 flows over a short section through working medium tank 15. The distance between the outlet of second channel 20 and inlet opening 21 can be selected between 1 mm and 15 mm, wherein mixing of working medium 9 from the tank and working medium 9 from the circuit depends on the distance. Also, the minimum working medium level in working medium tank 15 must be above inlet opening 21 to ensure that no air enters into filling channel 12.

The pressure of the control air in expansion region 27 regulates the working medium volume in the circuit, which in turn determines the braking torque of the retarder. This control of the braking torque is standard and is therefore not discussed in further detail.

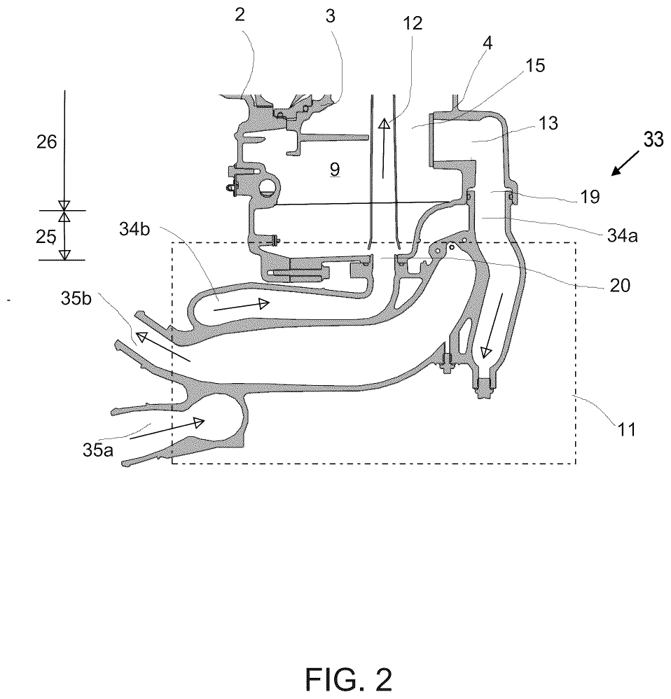

FIG. 2 illustrates an alternative design of the lower part of the oil tank with sump and intermediate component 33. This design differs from the representation in FIG. 1 essentially in that first channel 19 is positioned higher than second channel 20. When switching to braking mode, working medium 9 enters the retarder circuit via filling tube 12, and during braking mode a working medium stream exits second channel 20 after flowing through heat exchanger 11, flows briefly through working medium tank 15 and enters filling tube 12 through inlet opening 21.

The position of first channel 19 may be selected at random, since return channel 13 is connected here, which establishes a direct connection to working chamber 14. Return channel 13 can be a channel that is cast into one or more of the following components: rotor housing 2; stator housing 3; and/or tank housing 4. Alternatively, the return channel can also be designed as a pipeline. The arrangement on a different level enables, among other things, different sealing concepts so that tolerances can be better compensated, here once axially in connection level 18 and once radially by inserting nozzles at intermediate component 33 into second channel 20.

The cross-sectional representation of intermediate component 33 also shows an exemplary progression of channels 34a, 34b for working medium 9 and channels 35a, 35b for the cooling water. An outlet 30a, 30b is provided for the working medium circuit and the cooling water circuit respectively. In particular, the working medium can drain completely out of the working medium circuit of the retarder via outlet 30a for the working medium.

### COMPONENT REFERENCE LISTING

1 Retarder
2 Rotor housing
3 Stator housing
4 Tank housing
5a, b Bearing
6 Rotor
7 Stator
8 Rotor shaft
9 Working medium
10 Seal
11 Heat exchanger
12 Filling channel
13 Return channel
14 Working chamber
15 Working medium tank
16 Coupling level
17 Connection
18 Connecting level
19 First channel
20 Second channel
21 Inlet opening
22 Outlet opening
23 Inlet chamber
24a, b Coupling level
25 Sump region
26 Storage region
27 Expansion region
29 Retarder chamber
30a, b Outlet
33 Intermediate component
34a, b Channel
35a, b Channel
X Distance

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A hydrodynamic retarder, comprising:
a stator;
a rotor, which is rotatably mounted;
a retarder chamber in which the rotor and the stator are arranged, the rotor and the stator together forming a working chamber that is configured for being filled with and emptied of a working medium;
a working medium tank, which includes a sump region, a storage region, and an expansion region, the sump region and the storage region being configured for accommodating the working medium that is not currently in the working chamber;
at least one filling channel configured for supplying the working medium into the working chamber;
a return channel configured for discharging the working medium from the working chamber;
a rotor housing;
a stator housing;
a tank housing;
a coupling level, which is arranged on the tank housing below the sump region; and
at least one additional channel, which runs through the coupling level and is configured for direct or indirect coupling to an outlet of a primary side of a heat exchanger.

2. The hydrodynamic retarder according to claim 1, further including a first channel, which is arranged in the tank housing and is configured for direct or indirect coupling with an inlet of the primary side of the heat exchanger, the at least one additional channel being at least one second channel.

3. The hydrodynamic retarder according to claim 2, wherein the first channel is arranged above the at least one second channel.

4. The hydrodynamic retarder according to claim 1, wherein the at least one filling channel extends into the sump region and includes an inlet opening which is covered by at least 20 mm to 50 mm of the working medium during every operating state.

5. The hydrodynamic retarder according to claim 4, wherein the inlet opening of the at least one filling channel is located centered above the at least one second channel.

6. The hydrodynamic retarder according to claim 2, further including an intermediate component, the heat exchanger, and a first plurality of channels, wherein the heat exchanger includes the primary side which includes the inlet and the outlet, wherein the intermediate component is between the tank housing and the heat exchanger, wherein the first plurality of channels are integrated into the intermediate component and are that by way of which the first channel is connected to the inlet of the primary side of the heat exchanger and the at least one second channel is connected to the outlet of the primary side of the heat exchanger.

7. The hydrodynamic retarder according to claim 6, wherein the heat exchanger includes a secondary side, the hydrodynamic retarder further including a second plurality of channels which are integrated into the intermediate component and are that by way of which the secondary side of the heat exchanger are configured for being connected to a cooling circuit.

8. The hydrodynamic retarder according to claim 6, wherein the intermediate component is a cast part with a plurality of cast-in channels.

9. The hydrodynamic retarder according to claim 6, wherein the heat exchanger includes a primary circuit, wherein the intermediate component includes a first outlet which is configured for being that through which the working medium is drained from the working medium tank and the primary circuit of the heat exchanger.

10. The hydrodynamic retarder according to claim 6, wherein the heat exchanger includes a secondary circuit, wherein the intermediate component includes a second outlet which is configured for being that through which a cooling medium is drained from the secondary circuit of the heat exchanger.
